(19) United States
(12) Patent Application Publication
(10) Pub. No.: US 2011/0168031 A1
(43) Pub. Date: Jul. 14, 2011

(54) AUTOMATIC FRYING APPARATUS FOR FOODSTUFFS

(76) Inventor: Jim Vadevoulis, Riverwoods, IL (US)

(21) Appl. No.: 12/571,001

(22) Filed: Sep. 30, 2009

Related U.S. Application Data
(63) Continuation of application No. 10/963,409, filed on Oct. 12, 2004, now abandoned.

(51) Int. Cl. A23B 4/052

(52) U.S. Cl. 99/352

(57) ABSTRACT

An automated apparatus and method for sequentially slicing potatoes into slices, for cooking the slices into chips in a circular oil bath, and for separating the cooked chips from the bath. The apparatus includes a potato slicer, a circular frying trough with oil circulating means and controlled heating means, a rotating and angle changing plurality of circularly arranged paddles for positioning chips in and along the trough during their cooking, a carousel for lifting and separating cooked chips from the trough, and a conveyor belt for delivering the chips from the carousel to a collection point. The method utilizes the apparatus.

### CROSS-REFERENCE TO RELATED APPLICATION(S)

The present application is a continuation of prior U.S. application Ser. No. 10/963,409, filed Oct. 12, 2004, titled “Automatic Frying Apparatus for Foodstuffs,” the entirety of which is incorporated herein by reference.

### FIELD OF THE INVENTION

This invention relates to automatic frying apparatus for foodstuffs, such as potato chips and the like, to methods of using the apparatus, and to subassemblies useful in such apparatus.

### BACKGROUND

Apparatus for automatically frying foodstuffs, such as apparatus that slices potatoes, fries the slices to produce potato chips, and removes the resulting chips, has been previously attempted. For example, apparatus for slicing potatoes, frying the slices into potato chips in a longitudinally elongated pan holding a cooking oil bath, and removing the chips on a conveyor is described in Smith et al. U.S. Pat. No. 6,602,533.

However, this apparatus appears to suffer from various disadvantages. It is believed that these disadvantages would be overcome by an improved apparatus which would achieve better control of cooking temperatures and times, better separation of cooked chips from cooking oil, and better capacity to produce in succession different batches of customized chips. Also, it would be desirable to have improved oil filtration and contaminated oil separation means for association with the apparatus.

The present invention provides new and very useful automatic foodstuff frying apparatus that overcomes the prior art disadvantages and achieves apparatus which in a present embodiment is particularly useful for making potato chips in successive batches.

### SUMMARY

More particularly, the present invention relates to automatic apparatus for making fried foodstuffs, such as chips from potatoes or the like.

In a preferred embodiment, the apparatus incorporates a toroidal trough for holding a cooking oil bath and a pump for circumferentially circulating oil comprising the bath through the trough. Preferably, the apparatus is associated with oil heating and temperature regulating means.

The trough is preferably associated with a rotatable circular subassembly incorporating a plurality of paddles. The subassembly is rotatably driven by a motor. The circular paddle subassembly is generally coaxial with the trough. Individual paddles of the paddle plurality travel during rotation along a predetermined pathway or orbit extend over and into the trough through guidance provided by associated cam means that is preferably adjustable. The paddles and the pathway are adapted to manipulate frying foodstuffs such as chips in the flowing cooking oil bath. The cam means functions to provide selective tilting and arcuate movements of individual paddles during paddle subassembly rotation.

To accommodate conveniently a foodstuff slicer subassembly, and also a cooked foodstuff removal subassembly, an outer side wall region of the trough is preferably formed by a pair of laterally outwardly projecting side wall portions that terminally join to define an apex that preferably extends vertically and at which these wall portions preferably connect perpendicularly. A starting slicer subassembly is associated with and overhangs the trough along a first such side wall portion, and a terminal removal subassembly is associated with and overhangs that trough along the second one of such side wall portions. The direction of oil flow in the trough is preferably such that the second side wall portion is located downstream relative to the first side wall portion.

When, for example, potato chips are being made, the slicer subassembly preferably incorporates an associated potato charging chute and potato slice discharge orifice. The slices are preferably sequentially discharged into the oil in the trough directly from the slicer subassembly. The fried slices (now chips) are removed from the trough oil by the removal subassembly. During contact with the trough oil, the frying chips are subject to manipulation in a selected and predetermined manner by the rotating, tilting and arcuately turning paddles of the paddle assembly. The chip removal subassembly preferably includes a rotating carousel and a translating conveyor belt. The circumferentially spaced seats of the carousel collect, elevate and discharge chips gravitationally onto the longitudinally outwardly advancing conveyor.

The frier apparatus preferably includes a computerized control system for regulating the operations of the apparatus and its subassemblies.

In addition, the invention includes a new and improved automated method for preparing fried foodstuffs, such as chips from potatoes and the like. The method utilizes the frier apparatus.

The frier apparatus is preferably associatable with a mobile oil filtration and used oil removal apparatus.

The invention additionally achieves novel and useful subassemblies and features associated with the frier apparatus. One new subassembly includes the combination of toroidal trough with oil pump and oil heating and temperature regulating means. Optionally, a trough oil level sensing and level control means may be included, if desired.

Another new subassembly includes the rotatable circular subassembly that incorporates a plurality of paddles and a paddle manipulating cam system, as indicated above.

A further new subassembly includes the combination of carousel and conveyor.

Another new subassembly includes a simple, optimized control system for ready and convenient operation of the apparatus and its incorporated subassemblies.

The frier apparatus and the subassemblies used therein are believed to overcome disadvantages found in prior art systems such as described above and to provide new and very useful apparatus and methods with slicing, slice frying and fried slice removal.

The frier apparatus and the associated method of use are believed to provide a new and very useful automated system for fried foodstuff preparation that can include, if desired, foodstuff slicing, slice frying and fried slice removal with features and advantages not previously known to the art. The apparatus and method are well suited for use in executing relatively small batch chip production operations and the like.

Other and further objects, aim, purposes, features, advantages, embodiments and the like will be apparent to those skilled in the art particularly when taken in combination with the disclosures and teachings of the present specification, the associated drawings and the appended claims.

### BRIEF DESCRIPTION OF THE DRAWINGS

In the drawings:

FIG. 1 is an environmental perspective view of one embodiment of the foodstuff frier apparatus of the present invention with the belt of the conveyor removed for illustration purposes;

FIG. 2 is an exploded fragmentary perspective view of the frame and supporting cabinet of the FIG. 1 apparatus, the components in FIG. 2 being uniformly rotated clockwise 90.degree. relative to their spatial orientation shown in FIG. 1;

FIG. 3 is an exploded, fragmentary perspective view showing the combination of toroidal oil trough and movable paddles of the FIG. 1 apparatus, this view being in the same component spatial orientation as in FIG. 2;

FIG. 4 is a diagrammatic plan view of the cam arms employed in the FIG. 1 apparatus;

FIG. 5 is a view similar to FIG. 4 but showing the cam arms in a fragmentary perspective view;

FIG. 5A is a fragmentary perspective view illustrating a cover member for association with the foodstuff position regulating subassembly, the cover member overlying the mounting means of the individual paddle members;

FIG. 6 is a perspective view of one of the paddle subassemblies of the FIG. 1 apparatus;

FIG. 7 is an exploded perspective view of a blade portion of the paddle subassembly shown in FIG. 6;

FIG. 8 is an exploded perspective of the base portion of the paddle subassembly of FIG. 6;

FIG. 9 is a fragmentary plan view of the ring of paddle subassemblies illustrating the vertical orientation of paddle blades in the FIG. 1 apparatus when the cam follower of the base portion of the paddle assembly has been cammed to an extent such that the blade portions of paddle assemblies are in a vertical orientation;

FIG. 10 is a somewhat diagrammatic plan view of the FIG. 1 apparatus illustrating the oil flow system;

FIG. 11 is a fragmentary perspective bottom view of the FIG. 10 apparatus, some portions thereof being broken away, illustrating further the oil flow system shown in FIG. 10;

FIG. 12 is a perspective view of one embodiment of a potato slicer subassembly employable in the apparatus of FIG. 1, some parts thereof being broken away;

FIG. 13 is an exploded fragmentary perspective view of another embodiment of a potato slicer subassembly employable in the apparatus of FIG. 1;

FIG. 14 is a perspective view of undersurface portions of the knife blade, ring gear and wiper blade subassembly employed in the slicer of FIG. 13;

FIG. 15 is an enlarged perspective view of upper surface portions of the cutting and wiping chamber defined by the chamber-defining component of the slicer subassembly of FIG. 13, this component being rotated 90.degree. relative to its orientation in FIG. 13;

FIG. 16 is a view similar to FIG. 15 but showing the lower surface portions of the chamber-defining component;

FIG. 17 is a fragmentary perspective view of the carousel subassembly of the FIG. 1 apparatus;

FIG. 18 is a diagrammatic side elevational view of the carousel subassembly of FIG. 17 illustrating the manner of supporting and rotating the carousel;

FIG. 19 is a fragmentary, exploded, detailed perspective view illustrating the seat structure of the carousel of FIG. 17;

FIG. 20 is a perspective view of the combination of the carousel subassembly (as shown in FIGS. 17-19) and the conveyor belt subassembly comprising the chip removal subassembly of the FIG. 1 apparatus;

FIG. 21 is a perspective view of the combination of FIG. 20 but showing the conveyor belt assembly in the separated position for maintenance and the like;

FIG. 22 is a schematic representation in linear form illustrating the progressive potato slicing, slice/chip cooking (frying) and chip removal sequence utilized in operation of the FIG. 1 apparatus;

FIG. 23 is a block diagram of a presently preferred control system for the FIG. 1 apparatus;

FIG. 24 is a block diagram of a presently preferred oil temperature control system for the FIG. 1 apparatus; and

FIG. 25 is a block diagram of a presently preferred motor control system for the FIG. 1 apparatus.

### DETAILED DESCRIPTION

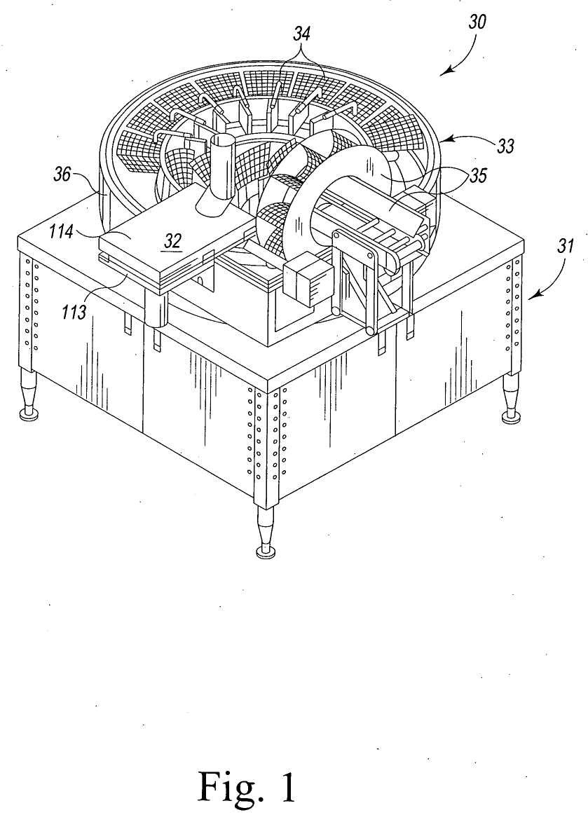

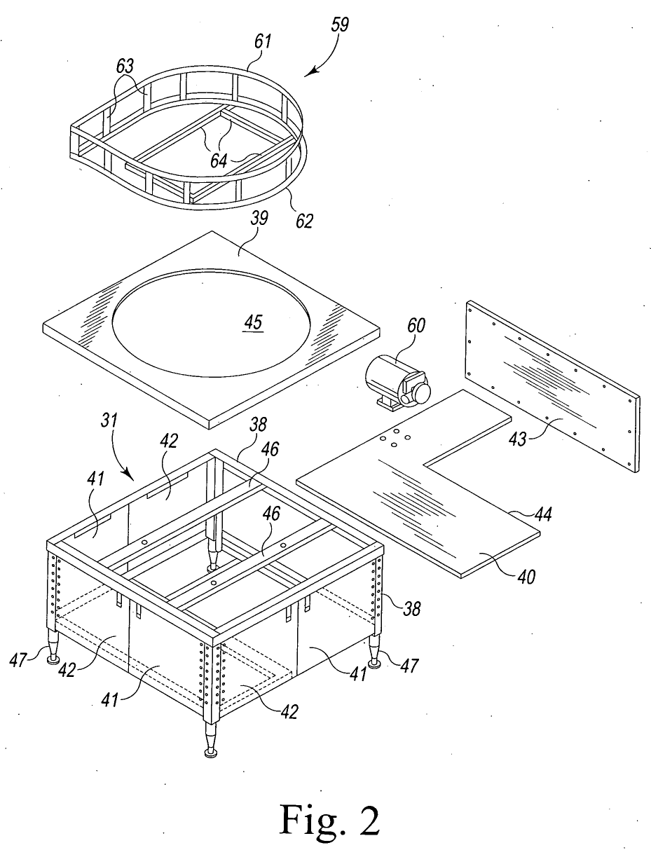

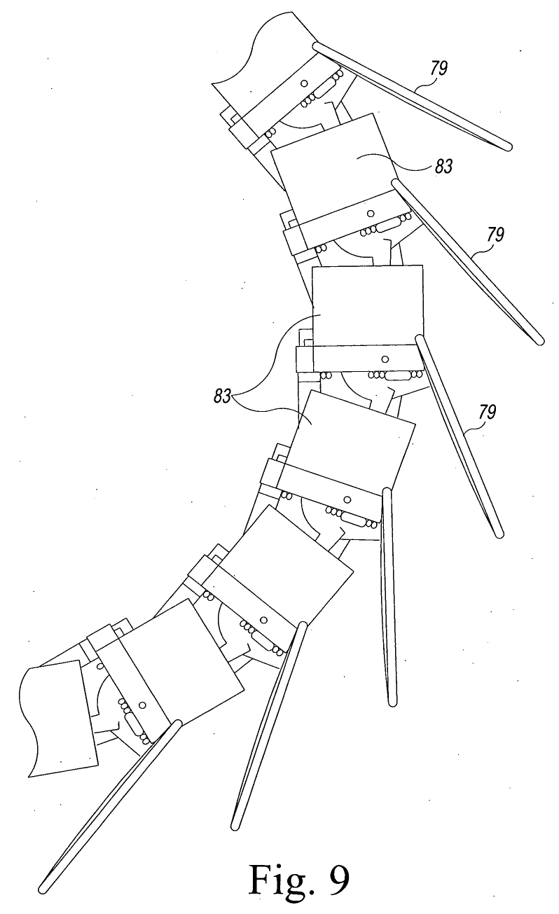

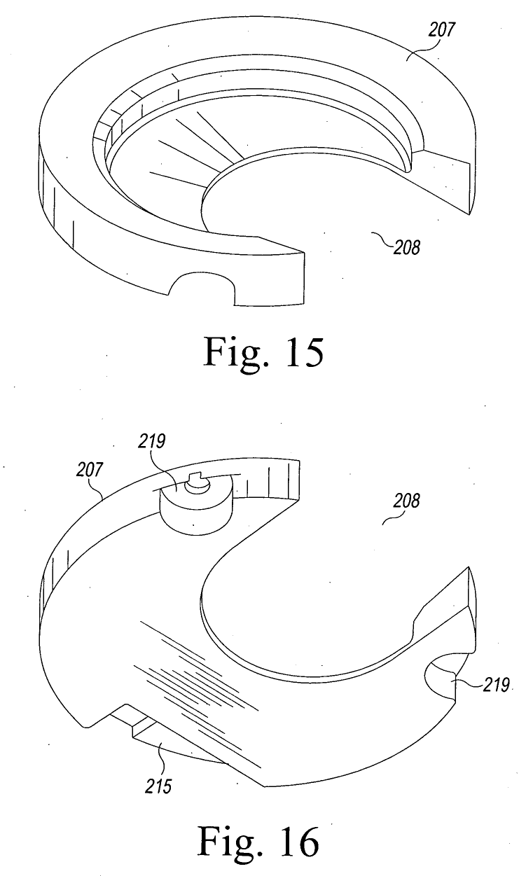

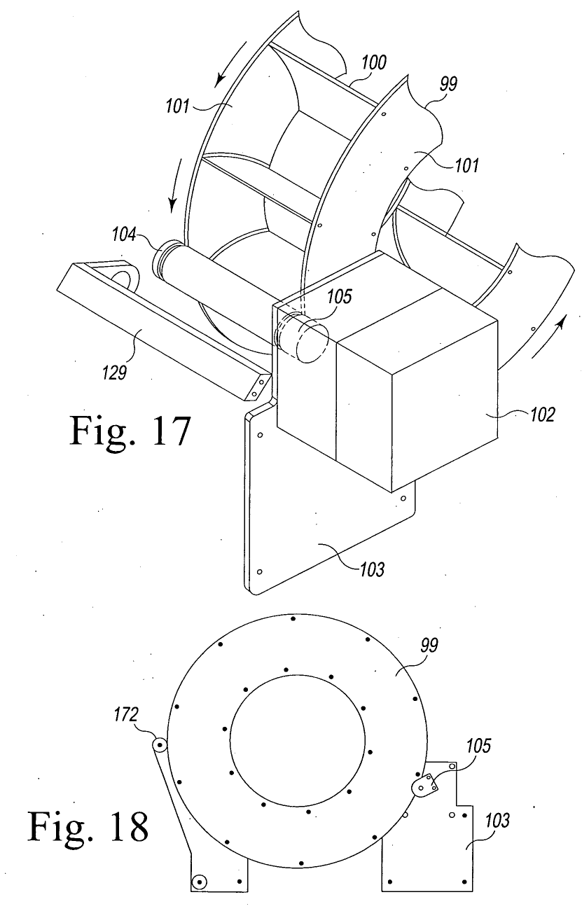

Referring to FIGS. 1-25, an embodiment 30 of automated chip production apparatus of the present invention is illustrated. As shown in FIGS. 1 and 2, the apparatus 30 is illustratively supported on a cabinet-type platform 31. The illustrative cabinet-type support platform 31 includes a frame 38 comprised of a plurality of interconnected (preferably by welding) structural angle iron members, two laterally spaced top deck medial cross supports 46, four adjustable legs 47, a top deck 39 and a lower shelf 40. Three sides of platform 31 are each provided with side door pairs 41, 42, and the fourth side is provided with a panel 43. The top deck 39 has a large circular aperture 45 centrally defined therethrough. The lower shelf 40 is generally L-shaped, thereby defining therein adjacent a corner region thereof a rectangular opening 44 which is utilized as a docking site for a preferably commercially available mobile used oil receiving and preferably also filtering caddy, as discussed below.

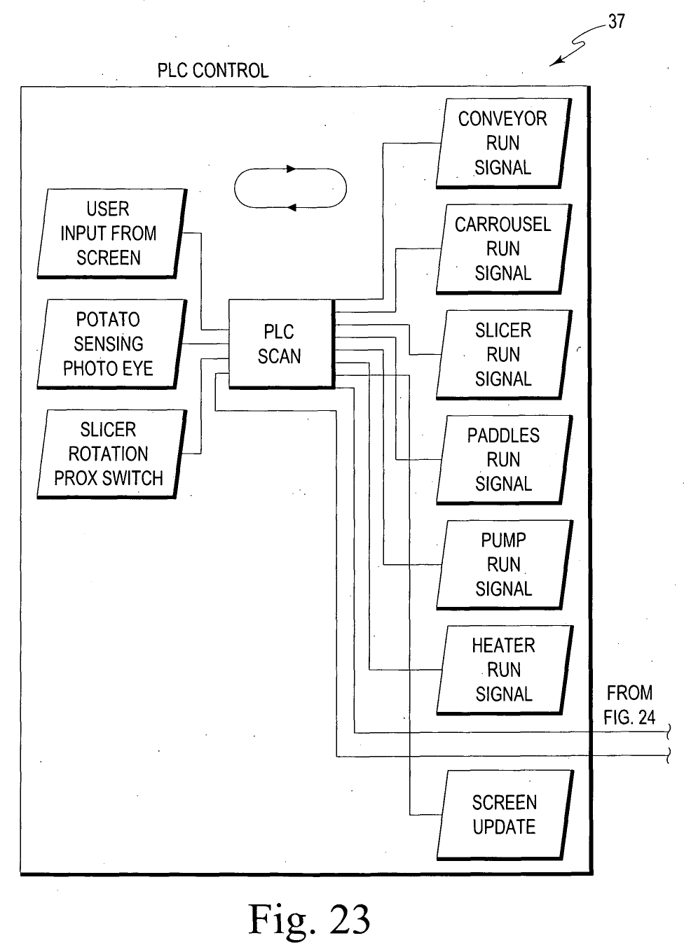

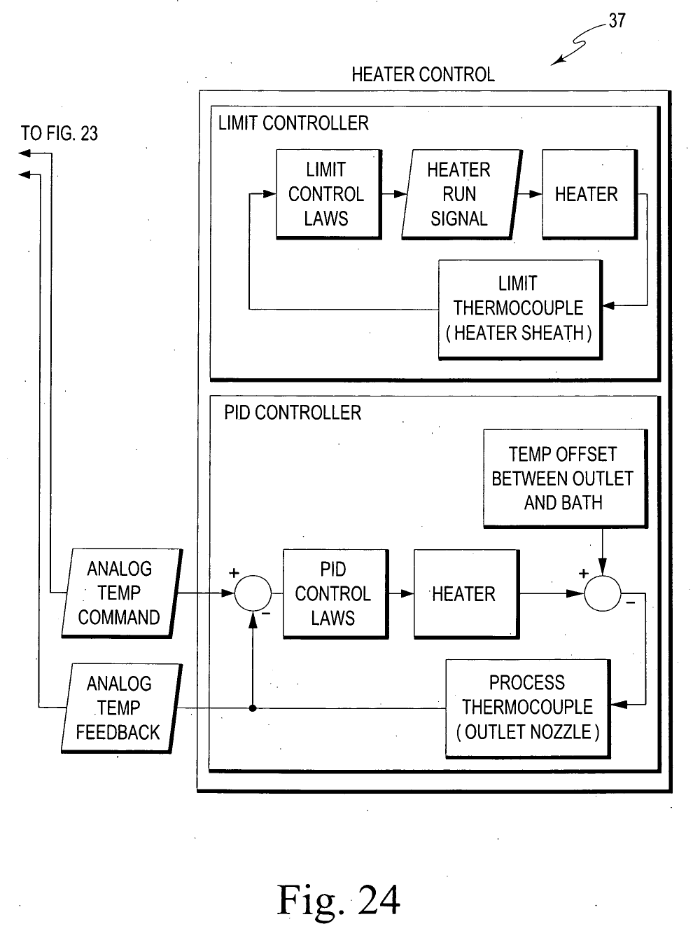

The apparatus 30 preferably incorporates a toroidal trough or oil pan 51 in association with a motor driven pump 60 for circumferentially circulating cooking oil (not shown) in the trough 51. The trough can also be oval or egg-shaped, for example. In a presently preferred embodiment, such as apparatus 30, there is included in combination and functional association a toroidal oil holding and frying trough subassembly 33 that incorporates a trough 51, a pump 60, and preferably an oil temperature regulating subassembly 68; a foodstuff (illustratively, a potato chip) trough position regulating subassembly 34 that includes a circular, rotatable plurality of circumferentially adjacent paddle assemblies 78 that orbit, tilt and arcuately incline; a foodstuff (illustratively, a potato) slicer subassembly 32; a foodstuff (illustratively, a potato chip) removal subassembly 35 that preferably includes a rotating carousel 99 and a translating conveyor belt 130; and preferably a control system 37 (not shown in FIG. 1, but see FIGS. 23-25). For decorative purposes, outer side wall portions of apparatus 30 may be provided with a jacket 36 comprised of sheet metal or the like which can be variously configured; for example, jacket 36 can resemble side portions of a copper kettle, or otherwise, as desired, as those skilled in the art will readily appreciate.

### Oil Trough Subassembly

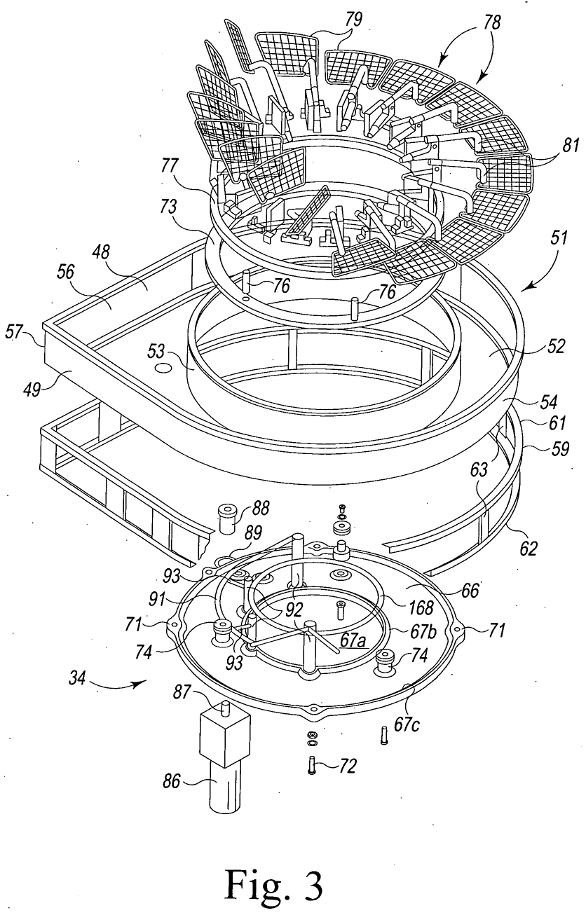

In the trough subassembly 33, the generally toroidally configured, oil-holding trough 51 (see FIG. 3, for example) preferably has a generally flattened bottom wall 52, a continuously interconnected, upstanding, generally circular, inside wall 53, and a continuously interconnected, upstanding, outside wall 54. The outside wall 54 is generally circular but preferably (and as shown) includes and defines a side-wise, outwardly extending excursion region 56 whose outside perimeter is defined by a circumferentially adjacent pair of outside wall portions 48 and 49 that each extend from an inner end region thereof preferably straight and tangentially outwards from respective circumferentially spaced locations along the outside wall 54. The straight outside wall portions 48 and 49 meet at their respective outer end regions and define a right angled (90°) side apex 57 that extends vertically for the height of the outside wall 54. The bottom wall 52 in the excursion region 56 correspondingly outwardly extends and continuously interconnects with the outside wall portions 48 and 49 along bottom edge portions thereof. If desired, alternative configurations for the excursion region 56 can be used, depending upon objectives. The oil-holding trough 51 with its walls 52, 53 and 54 (taken with portions 48 and 49) is preferably comprised of stainless steel (including weldments) and preferably has rounded or rolled upper edge portions, as shown.

The outside wall 54 of trough or pan 51 is provided with an adjacent, enclosing, upstanding support fence 59 that preferably includes upper and lower railings 61 and 62, respectively, which are preferably each comprised of angled stainless steel, and which are interconnected together in vertically adjacent, spaced, parallel relationship by a plurality of perimetrically spaced, flattened interwelded together spacer members 63, each preferably comprised of stainless steel. Portions of lower railing 62 are connected to and support projecting portions of a rectangular, transversely extending and transversely oriented bottom frame subassembly 64 (see, for example, FIG. 2) that is conveniently comprised of screwed together (preferred) or interwelded together lengths of bar stainless steel. When the fence 59 is centered over the opening 45 in top deck 39 with the top deck 5 39 in position on the platform 31, the frame subassembly 64 extends over the opening 45. The frame subassembly 64 supports the oil pan 51 when the oil pan 51 is positioned horizontally within the fence 59 in the assembled apparatus 30. Fence 59 provides support for the trough 51, the slicer subassembly 32, the removal subassembly 35 and the base 66.

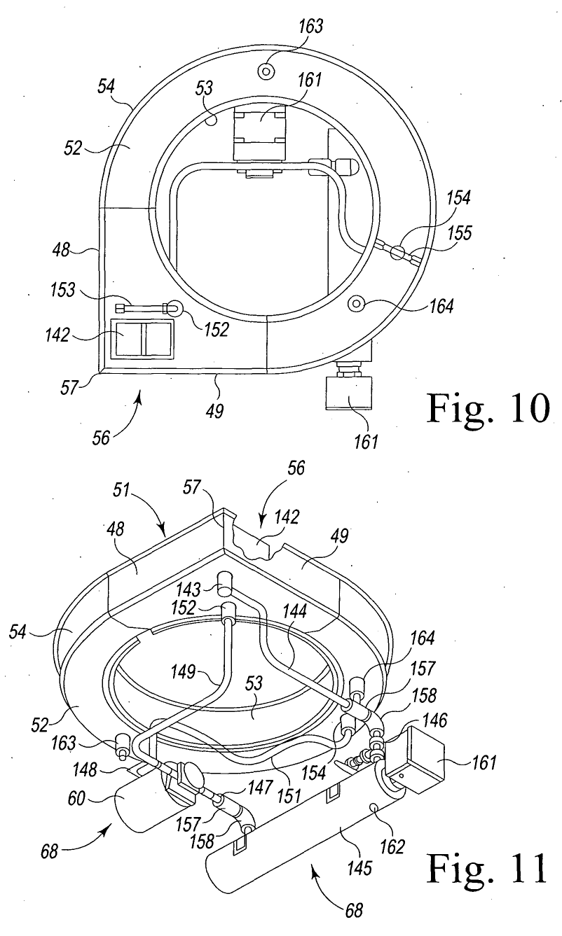

Trough 51 is associated with a pump 60 that is mounted on pump mount 161 which is associated with frame 64 and fence 59 and also preferably with an oil temperature regulating subassembly 68 as illustratively shown, for example, in FIGS. 10 and 11. After traveling around the interior of the trough or pan 51, oil passes through a conventional oil filter 142 and exits the trough 51 through a port 143 that is preferably and conveniently located in the bottom 52 adjacent the apex 57 as defined by the wall portions 48 and 49. The filtered oil passes to an electric heater 145 through a conduit 144 past a process thermocouple 146 that senses the oil temperature. The oil is heated in heater 145 to a desired predetermined temperature using a temperature control loop, as known to those skilled in the art, a presently preferred temperature control system being illustrated in FIG. 24. From the heater 145, the oil passes through a conduit 147 into the electric motor-associated (conventional) pump 60. Oil exiting the pump 60 is split at a T-fitting 148 into separate streams that pass into conduits 149 and 151. The oil in conduit 149 is delivered to a port 152 in the bottom 52 of trough 51 and passes into, through and out from an elongated spray head 153 that extends angularly across and adjacent to the interior bottom of the trough 51 adjacent the apex 57. The sprayed entering oil from the head 153 is useful in getting the foodstuffs, such as chips, that are dropped into the oil in the trough 51 from the slicer subassembly 32 or the like (as described below) flowing in a clockwise direction in the clockwise moving oil in the trough 51.

The oil in conduit 151 is delivered to a port 154 in the bottom 52 of trough 51 and passes into, through and out from an elongated spray head 155 that extends across and that is adjacent to the interior bottom of the trough 51. The spray head 155 is preferably located about 1600 beyond the spray head 153 in the trough 51. The spray heat 155 preferably functions to provide oil currents that are useful in moving foodstuffs, such as cooked chips, in the frying oil bath onto respective seats 100 of the revolving carousel 99, as described below, for removal from the bath. The conduits 144, 147, 149 and 151 can be comprised, for example, of oil-resistant, food contact grade, conventional hose fitted as necessary or desirable with mating fittings, such as couplings 157 and 158. Electric connecting means are generally not shown in FIGS. 10 and 11 for simplicity, but electric control box 161 is shown illustratively.

At the end of a period of apparatus 30 operation, for example, as the end of a day of operating, an operator can open a valve 162 in the heater 145 and drain out oil from the trough 51 into a conventional oil caddy (not shown) or the like. Various oil caddys are commercially available. One present preference is to use a mobile (wheel mounted) oil caddy that is equipped with an auxiliary oil filtering system and with a pump so that oil drained into the caddy can be recirculated therein and subjected to filtering, thereby enabling further use of the oil which can then be pumped by the caddy pump back into the apparatus 30 through the valve 162. Alternatively, oil drained from valve 162 into the caddy can be delivered in the mobile caddy to an environmentally acceptable disposal station or the like (not shown). Preferably, the trough 51 is provided with additional valved ports 163 and 164 for possible or optional use in cleaning or maintenance.

The oil fill level in the oil pan 51 is preferably maintained and regulated within a predetermined level. While the oil level can be automatically controlled, if desired, using preferably a computerized control system or the like, it has been found convenient, satisfactory and simple for an operator to determine the fill level and to manually control the oil fill level in the trough 51. The operator can add make-up oil to trough 51, for example, as needed during operations. In a start up mode for apparatus 30 operation, the operator can initially fill the oil pan 51 with cooking oil until a desired fill level is reached after which the operator can actuate the oil pump 60 and the oil heater 145. In another operating mode, the oil can be charged from an oil caddy through the valve 162 until a desired trough 51 fill level is reached after which the caddy pump can be deactuated, the valve 162 closed, and the pump 60 and heater 145 actuated. Various oil flow and usage arrangements can be utilized as those skilled in the art will readily appreciate.

In apparatus 30 operation, the oil is pumped by pump 60 at a rate and volume which causes the oil in pan 51 to circulate circumferentially and clockwise through the pan 51 at a predetermined or desired velocity. A present preference, particularly for reasons of easy, simple operation by an operator, is for the oil flow rate to be faster than the rotation rate of the circular plurality of adjacent paddle assemblies 78 in the trough foodstuff position regulating subassembly 34.

### Position Regulating Subassembly

To regulate the frying of foodstuffs (such as chips) in the trough 51, a foodstuff position regulating subassembly 34 is preferably provided. However, as those skilled in the art will appreciate, if desired, foodstuffs can alternatively be fried in a circulating oil bath in the trough 51 by direct operator control or by other foodstuff position regulating means, not shown.

In the trough position regulating subassembly 34 of the apparatus 30, a circular, rotatable plurality of circumferentially adjacent paddle assemblies 78 orbits and individual blade members 79 of the paddle assemblies 78 tilt and arcuately incline over and in the trough 51.

The subassembly 34 incorporates a circular base plate 66 (see, for example, FIG. 3) that is centered within the opening 45 and rests upon the cross supports 46. The base plate 66 has a central circular opening 67a that provides an access for ventilation. In the base plate 66, a raised, circumferentially extending, inner edge 67b extends around opening 67a, and a raised, circumferentially extending out edge 67c extends about the perimeter of the plate 66. A plurality of preferably circumferentially spaced, radially outwardly projecting, apertured ears 71 (preferably four, as shown) are provided about the perimeter of the plate 66. The plate 66 rests on, and the ears 71 are vertically aligned with, portions of the underlying cross supports 46 (see, for example, FIGS. 2 and 3) of platform 31, and each of the ears 71 is mounted thereto with a countersunk cap screw 72 or the like that is extended through aligned apertures in each ear 71 and the cross supports 46.

A ring gear 73 is rotatably mounted on a vertical axis by a plurality (preferably three) guide bearing assemblies 74 over and adjacent to the base plate 66. The stem of each guide bearing assembly 74 is mounted perpendicularly to the base plate 66. Coaxially extending in axially spaced, parallel relationship relative to and over the ring gear 73 is a mounting ring 77. The mounting ring 77 is fixed to the ring gear 73 by a plurality (preferably six) of upstanding, circumferentially spaced, opposite end interconnected spacers 76 that each extend between vertically adjacent side portions of the mounting ring 77 and the ring gear 73. The spacers 76 are attached thereto by means of screws (not detailed) which threadably associate with each spacer 76 opposite end and which extend through respective sidewall portions of each of the mounting ring 77 and the ring gear 73.

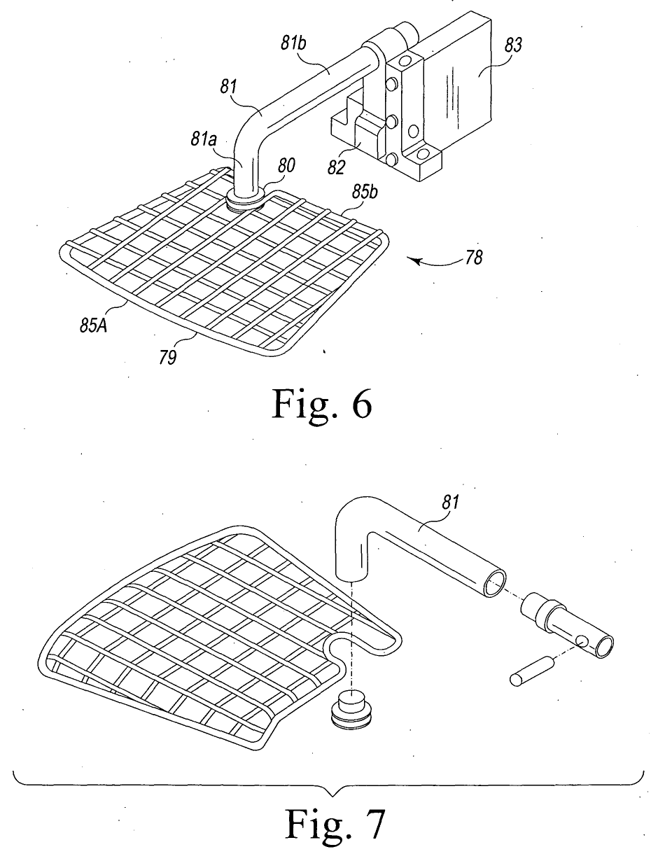

Mounted on the mounting ring 77 in circumferentially adjacent relationship to one another is the plurality (preferably 18) of paddle subassemblies 78. Each paddle subassembly 78 (see, for example, FIGS. 6-8) includes a generally flat paddle blade member 79, a connecting arm 81 and a base mount 82 having a cam follower 110. Each paddle blade member 79 has an open mesh structure and a perimeter configuration that is comparable to a trapezoid, but the opposed long and the short end sides 85a and 85b, respectively, are each preferably slightly curved longitudinally and generally parallel to one another, as shown. Preferably, the perimeter of each paddle member 79 is defined by a continuously extending heavy wire, and the internal area embraced within the thus defined perimeter is comprised of a grid defined by a plurality of straight smaller wire strand members that include a set of cross strand members and a set of transverse strand members. The respective wire strand members of each set are each in spaced, parallel relationship relative to each other and the sets define generally square openings between adjacent pairs of parallel wires in each set. All the wire members are welded together at points of contact (including crossover) therebetween.

Near one side edge of each paddle member 79 in the short end side 85b, a discontinuity or inwardly extending pocket 80 is defined. As illustrated in FIG. 7, for example, it is preferred to have the leading edge of a paddle member 79 be upwardly inclined since such an incline is believed to function to prevent foodstuff chips or the like in the oil bath from riding up over the top of an individual paddle blade member 79 during operation of the apparatus 30.

Each discontinuity 80 is associated with an outer end portion of a connecting arm 81. Each arm 81 is elongated and generally L-configured so as to define a relatively short forearm portion 81a and a relatively long upper arm portion 81b. The outer end portion of the short forearm portion 81a is preferably fixed to each paddle member 79, and, as so associated, the angle and orientation of arm 81 is such that the forearm portion 81a extends generally perpendicularly relative to the associated paddle blade member 79. The outer end portion of each forearm portion 81a is conveniently thus mounted by welding or the like to a paddle blade member 79. The long upper arm portion 81b extends outwardly from and above the short end side 85b. The outer end of the long upper arm portion 81b receives telescopically an inner terminal sleeve 108 that has a pin 109 extending diametrically through, and projecting from, the outer end thereof.

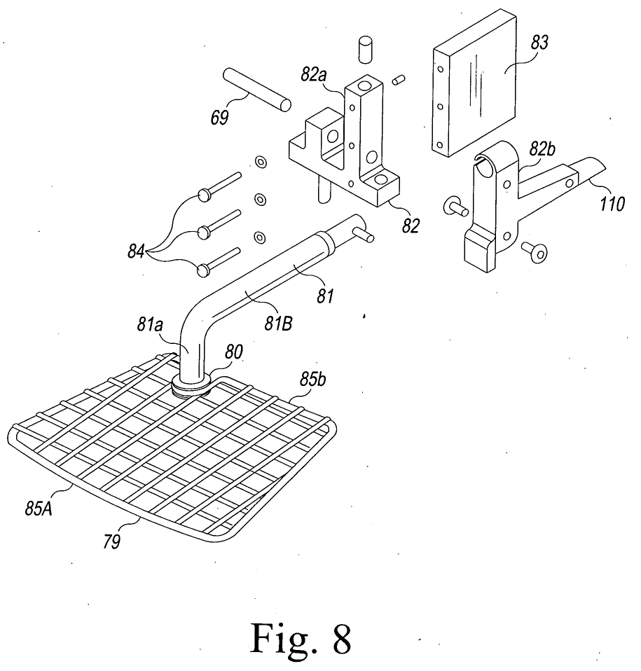

The base mount 82 is rotatably connected to the outer end portion of the upper arm portion 81b (see, for example, FIG. 8). The base mount 82 includes a base 82a and a cooperating arm lever 82b that interfits with and hinges on bushings (not detailed) and a pivot pin 69 relative to the base 82a mounts Screws (not detailed) extend through each opposite end of the bottom of base 82a and threadably engage mating holes in the mounting ring 77, thereby to mount a paddle subassembly 78 to the mounting ring 77. Extending outwards from the back of the base 82a is counterpoise 110 that is connected to the base 82a preferably by hex-headed screws 84 (three) or the like. Projecting from the outer end of the lever arm 82b is a cam follower 110. Thus, the arm 81 and associated blade member 79 are adapted to pivot and to radially move about the pin 69 responsive to a depressing camming force exerted on the cam follower 110 and the resulting elevation of the counterpoise 83 arcuately moves the pin 109 on the sleeve 108 so that the arm 81 pivots arcuately on its axis.

To revolve the ring gear 73 and the associated mounting ring 77, a conventional geared motor subassembly 86 (see FIG. 3, for example) is suspended from the base plate 66. The drive shaft 87 of the motor subassembly 86 extends through the base plate 66 and is keyed to a pinion gear 88 having a vertical axis, the pinion 88 being adapted to engage the perimeter gear teeth of the ring gear 73. Between the rotating, interconnected components 87/88 and the base plate 66 a preferably stainless steel seal 89 is positioned and fitted to plate 66. A clockwise direction of rotation for the ring gear 73 is utilized.

To achieve the indicated radial and arcuate movements of each of the connecting arms 81 as the circular plurality of paddle assemblies rotates, a circular cam arrangement is provided which incorporates a plurality of curved cam members. The cam members extend circumferentially around, and in radially inwardly spaced but adjacent relationship relative to, the mounting ring 77 so that the cam follower 110 of each paddle assembly 78 slidably and progressively engages surface portions of the cam members during rotation. The individual cam followers 110, by sliding over and following the contacted surface portions of the cam members, cause the respective individual paddle members 78 to move arcuately and radially as the mounting ring 77 rotates.

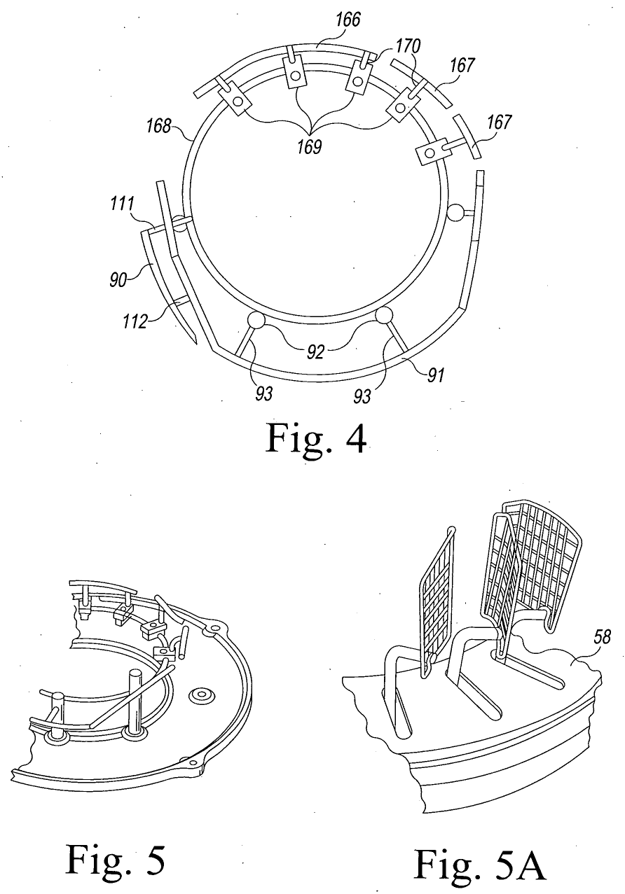

The cam arrangement includes a generally elongated and curved cam rod 91 (see, for example, FIGS. 3, 4 and 5) that is fixedly mounted in upwardly spaced relationship relative to the base plate 66 and circumferentially extends relative thereto by means of a plurality (preferably four as shown) of circumferentially spaced, perpendicular posts 92 that are rooted in the plate 66 and upstand perpendicularly therefrom in adjacent relationship relative to the raised inside edge 67b. Upper end portions of the posts 92 are each provided with a generally radially outwardly extending rail 93, three of which, as shown in FIG. 4, connect with respective adjacent inside portions of the cam rod 91. The cam rod 91 continuously extends over and around the base plate 66 for approximately 180° and includes beginning and terminal portions that are each inclined to better guide the cam followers 110. This cam rod 91 functions to raise and individual paddle assemblies and thereby permit them to clear the carousel 99 and the slicer assembly 32 as the plurality of paddle assemblies 78 revolves with the ring gear 73 and the mounting ring 77 in the assembled apparatus 30. The circumferentially extending mid-regions of the cam rod 91 are uniform, extend about 84 degrees, and are generally equidistant from the underlying base plate 66. The position of the cam rod 91 relative to the trough or oil pan 51 is such that the mid-regions of the cam rod 91 extend over the excursion region 56 of the trough 51 in apparatus 30.

An extension cam arm member 90 (see, for example, FIG. 4) is preferably also provided which helps to guide and lower the individual paddle assemblies 78 as they progress and descend towards the oil bath in the trough 51. The extension cam arm member 90 is provided with supporting rails 111 and 112 that connect the arm 90 to each of a post 92 and a portion of the cam rod 91.

The cam arrangement includes a medium length curved cam rod 166 (see, for example, FIG. 4) which succeeds after an interval the cam rod 91, which extends for about 60 degrees and which functions to help prevent foodstuffs (chips or the like) in an oil bath in the trough 51 from sticking to the paddle blades 79. Also included in the cam arrangement are a plurality (preferably two) of short length curved cam rods 167 which can each extend from about 10 to 20°, which are preferably located successively between the end of cam rod 166 and the beginning of the cam rod 91 and which function to help release foodstuffs (chips or the like) from adjacent surfaces in an oil bath in the trough 51. To provide adjustability for the cam rods 166 and 167, a cam ring 168 is mounted to the posts 92 so as to be located above and generally over about the inner edge 67b of the base plate 66. Adjustable conventional ring clamps 169 are provided which are each adapted to grasp a portion of the ring 168 and which each include a rail 170 that extends radially and that connects with a portion of a cam rod 166 or 167.

The cam follower 110 of each paddle subassembly 78 is adapted to slidably engage progressively over bottom portions of each cam 91, 90, 166 and 167 as the ring gear 73 rotates as driven by the pinion 88. After rotating past the cam 91, each cam follower 83 is briefly free and unengaged with any cam surface or the like. The interrelationship between each cam follower 83 and cam 91 is such that, during such disengagement, about 180° of gear 73 rotation, when the cam followers 83 of the paddle subassemblies 78 are not cam engaged, and the paddle subassemblies 79 are oriented in a generally horizontal configuration, such as illustratively shown in FIG. 3 for about 180° of rotation. In this configuration, the broad side of each individual paddle member 79 overlies a circumferential portion of the oil pan 51. The adjustable cam rods 166 and 167 provide for the achievement of different angles for the blades 79, between the cam rod 166 and the cam rod 91, if desired, as those skilled in the art will appreciate. The adjusted relationship of the cam rods relative to the blades 79 is such that a particular desired pattern of blade 79 movements are achieved in the apparatus 30 for foodstuff frying operation purposes.

During the portion of the gear 73 rotation when the cam followers 110 initially engage the cam 91, each individual paddle member 79 becomes progressively increasingly angularly inclined to a final extent that occurs when each cam follower 110 is over the mid-region of cam 91 where each individual paddle member 79 is placed in a generally vertical orientation and also is elevated by its arm 81 relative to the base plate 66 compared to its position when over the pan 51. As each cam follower 110 of each individual paddle assembly 78 approaches the opposite (or terminal) end region of the cam 91, the cam 91 terminal orientation allows each individual cam follower 110 to change its orientation whereby each individual paddle member 79 is progressively returned to its horizontal configuration. When circumferentially beyond the cam 91, the interrelationship between the various components is such that the horizontal paddle member 79 configuration is assumed and reached at a predetermined location which is somewhat downstream in a clockwise direction from the location along the oil pan 51 where the potato slices prepared by the potato slicer 32 are discharged from the slicer 32 and descend by gravity into the heated oil in the oil pan 51. The cam 91 and cam followers 110 thus cause the paddle members 79 of the individual paddle subassemblies 78 to be elevated and vertically oriented when the paddle members 79 are passing over the excursion region 56 of the oil pan 51, thereby avoiding any interference between the paddle subassemblies 78 and components of the apparatus 30 (the slicer subassembly 32 and the carousel/conveyor subassembly 35) that are located at and extend along and above the vicinity of the excursion region 56. After passing thereover, the paddle members 79 are lowered and horizontally oriented as the paddle members 79 pass over selected circumferentially extending portions of the oil pan 51. To shield the base mount 82 and associated components, the circular arrangement of paddle assemblies 78 is preferably provided with a generally toroidally configured cover plate 58 which has defined therein a plurality of elongated, radially extending slots 58a, there being one slot 58a for each arm 81 and along which each arm can radially move responsive to cam action as the paddle assemblies 78 rotate, as illustrated in FIG. 5A.

### Slicer Subassembly

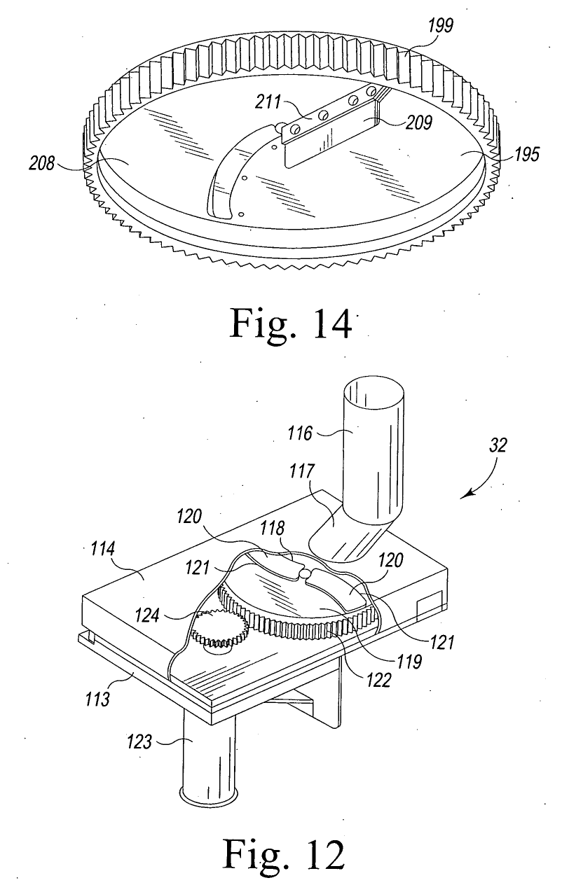

In apparatus 30, a potato slicer subassembly 32 is conveniently associated with and supported by the outside portion 48 and the fence 59 by a bracket (not detailed) with screws, clamps or the like, as desired. Preferably, the slicer assembly 32 is located along the wall portion 48 in the excursion region 56, and preferably the slicer subassembly 32 is positioned to overhang the oil pan 51 along side wall portion 48 so that slices cut by the slicer subassembly 32 can descend directly into the oil pan 51 in the excursion region 56. The slicer subassembly 32 (see, for example, FIGS. 1 and 12) includes a base 113 having a hinged cover 114 that pivots relative to the base 113 by means of hinges 115. Mounted to and upwardly extending from the cover 114 is an upstanding tubular feed chute 116 for potatoes and the like which preferably has an inclined lower terminal portion 117 that is adapted to position and incline potatoes or the like successively fed thereto so as to cause each so fed item to be sliced angularly and thereby produce slices of relatively large surface area. If desired, the feed chute 116 or the terminal portion 117 can be transparent or can include a transparent portion for viewing the potatoes during the slicing operation.

Rotatably mounted on a bearing (not detailed) associated with the base 113 is a stub shaft 118 having a vertical axis. Keyed to the shaft 118 is a cutting plate 119 having a longitudinally and radially extending (relative to shaft 118) pair of cutting blades 120 that are adapted to rotate together with plate 119, and adjacent to but in spaced, parallel relationship to, underlying adjacent surface portions of the base 113. Each blade 120 has a leading, convexly curved cutting edge, and each blade 120 is circumferentially flattened. The blades 120 have symmetrically arranged (relative to each other) slightly inclined side surface portions relative to the adjacent surface portions of the cutting plate 119. The blades 120 are in generally end opposed relationship relative to each other. Radially adjacent, opposed end portions of each blade 120 associated with opposite side portions of the shaft 118 extend radially outwardly from the shaft 118. A slice slit orifice 121 is defined in the plate 119 along the curved edge of each blade 120. Thus, individual slices cut by the blades 120 as the plate 119 rotates on shaft 118 are discharged through the orifices 121. If desired, the inclination angle of the blades 120 can be adjustable, if desired, (not shown) as those skilled in the art will appreciate, so that slices of predetermined, selected thickness can be achieved. Beneath the cutting plate 119, a portion (not shown) of the base 113 is open so that slices passing through the orifices 121 fall by gravity and can descend locally into the oil bath provided in the underlying pan 51 in the assembled apparatus 30.

The circumferential perimeter edge portions of the cutting plate 119 are provided with a ring gear 122. A conventional geared motor 123 with housing is suspended from the cutting plate 119, and the drive shaft of the motor 123 is keyed to a pinion gear 124 having a vertical rotation axis and located in spaced, adjacent relationship to the base 113 so that the pinion 124 is engageable with the ring gear 122. Thus, actuation of the motor 123 causes the ring gear 122 to rotate so that slicing can occur.

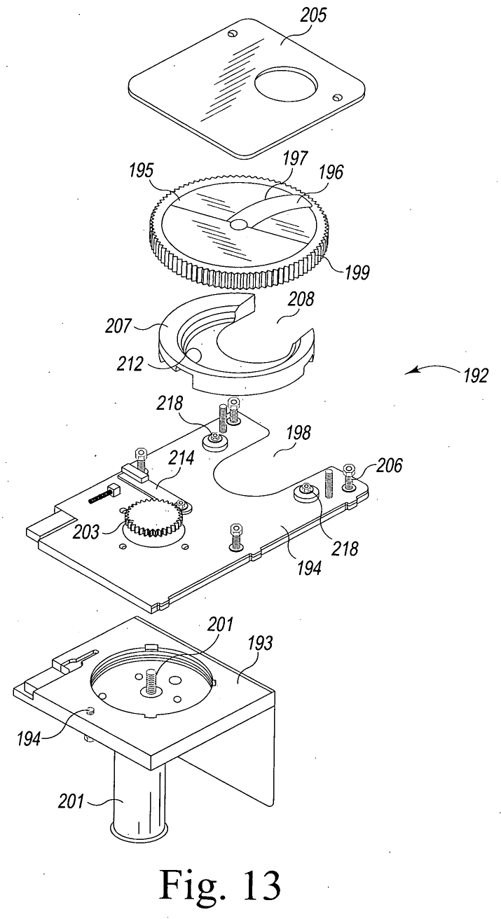

A preferred slicer subassembly 192, which is usable in place of the slicer subassembly 32 with similar interconnections with the side wall 48 and the fence 59, is illustrated in FIGS. 13-16. Other and various mounting arrangements can be employed if desired. Preferably, the slicer subassembly 192 is along the wall portion 48 in the excursion region 56 and overhangs the side wall 48 of the trough 51 so that slices cut by subassembly 192 descend vertically into the oil bath circulating in the trough 51 in the excursion region 56. The slicer subassembly 192 (see, for example, FIGS. 13-16) includes a base plate 193 that is covered by a pivotably associated yard plate 194 and that pivots relative to the base 193 by means of a pivot pin 194. Mounted to and upwardly extending from an apertured cover plate 205 is an upstanding tubular foodstuff (illustratively, potato) fee chute, not shown, which is similar to the chute 116/117 of the subassembly 32.

Rotatably mounted on rim bearings (not detailed) that are associated with the yard plate 194 is a circular cutting plate 195 that has a radially extending (relative to the plate 195) cutting blade 196. The plate 195 and associated blade 196 are adapted to rotate in adjacent spaced parallel relationship relative to underlying surface portions of the plate 194. Blade 196 has a leading, convexly curved cutting edge and is circumferentially flattened with slightly inclined and raised side surface portions relative to adjacent surface portions of the plate 195. A slice slit orifice 197 is defined in the plate 195 along the curved edge of the blade 196. Thus, individual slices cut by the blade 196 as the plate 195 rotates are discharged through the orifice 197. If desired, the inclination angle of the blade 196 can be adjustable (not shown), as those skilled in the art will appreciate. Beneath a portion of the plate 195 a U-shaped portion 198 located adjacent an edge of the plate 194 beneath the plate 195 is removed so that slices cut and passing through the orifice 197 can fall by gravity and descend directly into the oil bath in the underlying pan 51 in the assembled and operating apparatus 30.

The circumferential perimeter edge portions of the plate 195 are associated with a ring gear 199. A conventional housed geared motor 201 is suspended from the base plate 103 and the drive shaft 202 of the motor 201 is keyed to a pinion gear 203 having a vertical rotation axis and located in upwardly spaced, adjacent relationship relative to the plate 194 so that the pinion 203 is engageable with the ring gear 199. Actuation of the motor 201 causes the ring gear 199 and plate 195 to rotate so that slicing can occur when the cover plate 205 is associated with the plate 194 and positioned over the plate 195 by means of spacer nut and bolt assemblies 206.

A circular insert plate 207 is associated in a fixed position adjacent surface portions of the plate 194 and is sized to be received within a cavity 208 defined in the underside of the subassembly of plate 195 and ring gear 199. Preferably in contrast to other components of the slicer subassembly 197, which are preferably comprised of a metal such as stainless steel or the like, the plate 207 is conveniently formed by molding and machining and is preferably comprised of a durable plastic. One circumferential edge adjacent region 208 of plate 207 is removed so as to provide an opening that corresponds to the removed portion 198 and that can overlie same. Medial regions of the upper surface of the plate 207 are removed so that a chamber or cavity 212 is defined vertically between the medial upper surface regions of the plate 207 and medial undersurface portions of the plate 195. A radially extending scraper blade member 209 is provided that is generally diametrically aligned with the blade member 196 relative to the plate 195 and that is mounted to the undersurface of the plate 195 along the back side edge of blade member 209 by a bracket member 211 and rivets or screws (not fully detailed), as illustrated in FIG. 14. As the plate 195 rotates, the scraper blade 209 is adapted to sweep over and wipe adjacent surface portions of the plate 207 in the cavity 212 for the functional purpose of moving circumferentially any slices that might tend to adhere to the surface portions of the cavity 212 towards and out through the edge cavity 208 for deposition into the trough 51 oil bath. To aid in such movement of slices, the inside bottom face of the cavity 212 in the plate 207 is provided with a slight bevel that increases as the edge cavity 208 is approached.

For cleaning and maintenance purposes, the plates 194, 195, 207 and 205 are readily and simply assembled and disassembled relative to each other. For example, a spring-biased lever arm 214 pivots slightly to normally lockingly engage or disengage and separate (upon lever actuation) the plate 195 from the plate 194. To accommodate the lever arm 214, adjacent undersurface portions 215 of the plate 207 are removed, as shown in FIG. 16. In the subassembly 192, the plate 207 fits over and is retained against movements by locating pins 218 mounted in plate 194 that fit into sockets 219 defined in the undersurface portions 215 of the plate 207.

### Removal Subassembly

Fried foodstuffs in the trough 51 can be manually or automatically removed.

Preferably in the apparatus 30, removal is automatically accomplished preferably by a removal subassembly 35. Presently preferred is a removal subassembly 35 that incorporates a sequential combination of a rotating carousel 99 and a cooperating translating conveyor belt 130.

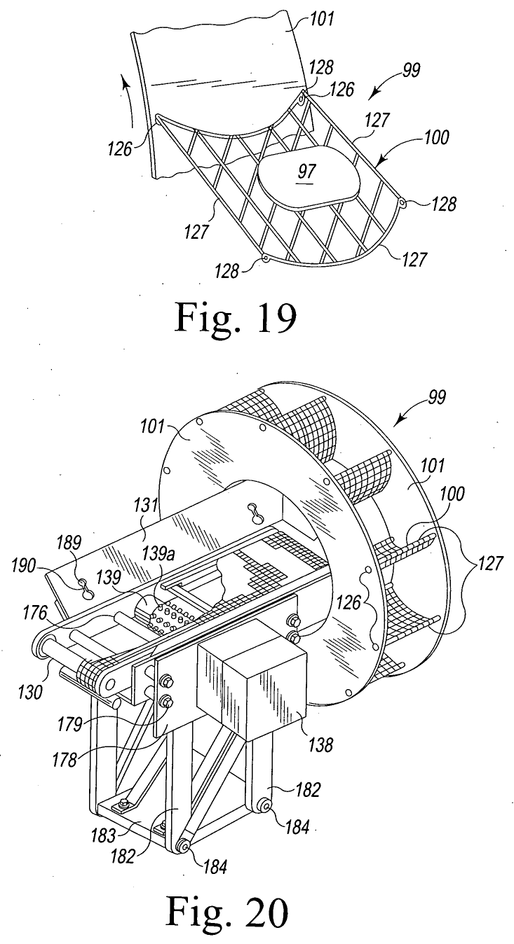

The carousel 99 (see, for example, FIGS. 1 and 17-21) incorporates a pair of transversely spaced, parallel side walls 101 preferably comprised of formed heavy stainless steel sheeting. The side walls 101 are each toroidally configured with radially spaced, circumferentially rounded outer and inner perimeter edge regions. Between the side walls 101, a plurality of circumferentially preferably equally spaced seats 100 are mounted. Each seat 100 is comprised of a wire mesh that is preferably formed of stainless steel. Radially spaced, parallel front and back edge portions of each seat 100 are associated with a straight stiffening wire 127 by welding or the like as detailed in FIG. 19. Each wire 127 extends parallel to the other in a seat 100, and each wire 127 is preferably comprised of stainless steel. For carousel 99 seat 100 mounting, opposite end portions of each stiffening wire 127 are provided with a downturned flange 128. A cross pin 126 (location indicated, pin not separately shown) extends through each flange 128 and an adjacent portion of a side wall 101. The cross pins 126 are each fixed by welding, thereby mounting each seat 100 between the side walls 101 with the wires 127 also supporting the side walls 101. Relative to the side walls 101, each of the seats 100 preferably generally extends radially but arcuately across each side wall 101 between the outer and inner edge region perimeters of each side wall 101 so as to define an upwardly (relative to the counterclockwise direction of carousel 100 rotation) concave seat depression medially therein. Each seat 100 is thus adapted to receive a chip 97 or the like, and to permit such chip 97 to rest thereon as the seat 100 continues its rotational advance after receiving the chip 97, and to permit the draining of cooking oil from chip 97 through the seat 100 mesh, as illustrated in FIG. 19, for example.

The carousel 99 is rim driven, as illustrated in FIG. 18, for example. The carousel 99 conveniently and preferably rests by gravity upon, and is positioned and supported by, the combination of a laterally spaced horizontal guide or idler roller 172 and a horizontal driven roller 104, each roller 172 and 104 preferably being provided with a pair of longitudinally spaced (relative to each roller 172 and 104) circumferentially extending grooves 173 that are adapted to receive matingly an adjacent outer circumferential rim edge portions of a different side wall 101. The idler roller 172 is associated with a support plate 171, and the driven roller 104 is supported by the motor 102, as indicated below, using the plate 103. The plates 103 and 171 are supported by the outside wall of 54 of the trough 51. In the apparatus 100, as so supported, the carousel 99 extends over and into the trough 51 and the lower edge portion of the carousel 99 is positioned to be immersed in the oil bath flowing in the trough 51 (see, for example, FIG. 1). To rotate the carousel 99 counterclockwise, as desired, a conventional housed geared motor 102 is mounted on a mounting plate 103. The roller 104 is keyed to the drive shaft 105 of the motor 102 and the roller 104, in alignment with rim portions of the side walls 101 of the carousel 99, rotatably drives the carousel 99 when the motor 102 is actuated. For cleaning and maintenance, the carousel 99 is simply lifted upwards and separated from the rollers 104 and 172.

As a safety device, a bracket 129 is preferably provided in the vicinity of the drive roller 104 to avoid hand contact by operators or spectators with the rotating shaft 104.

Cooked chips 97 or the like progressing in a flowing oil bath in trough 51 move onto individual seats 100 of the rotating carousel 99 and are carried upwards on the seats 100 as the carousel 99 rotates. When the seats 100 of the carousel 99 approach and reach about a vertical position, chips 97 resting on the seats 100 fall downwards by gravity away from the individual seats 100 generally radially relative to the carousel 99. The falling chips 97 are captured by (i.e., land on) surface portions of the advancing, translating cooperatively associated conveyor belt 130 that continuously operates and moves outwardly from about the mid central region of the carousel 99 (see, for example, FIGS. 1 and 20). To prevent falling chips 97 from floating or descending to one side or the other of the conveyor belt 130, or from landing beyond the inner end of the conveyor belt 130, a diagonally extending side baffle 131 is provided on each side of the belt 130 together with a diagonally extending end baffle 132 at the inner end of the belt 130. Chips 97 on the belt 130 are transported (carried) outwards laterally from the carousel 99 to a delivery and collection location (not detailed) which is conveniently and preferably at the forward end of the belt 130 and which is preferably along one side of the cabinet platform 31, as illustrated in FIG. 1, for example.

The conveyor belt 130 is conveniently and preferably comprised of an endless loop of mesh that is preferably comprised of stainless steel. Chips 97 on the belt 130 can thus drain excess oil through the mesh of the belt 130. To support the belt 130, a pair of transversely spaced side rails 176 is provided which are in a fixed relationship relative to each other as achieved by a plurality of longitudinally spaced cross supports 174 that are individually end mounted to each side rail 176. Between the adjacent spaced opposite ends of the side rails 176 pair a guide roll 177 is provided. Preferably edge guides (not fully shown) are also provided. Thus, the belt 130 is positioned between the rails 176 and extends over the guide rolls 177 and is adapted for endless translation.

Each of the side rails 176 is associated with a laterally adjacent support plate 178 by nut and bolt assemblies 179 with associated spacers. To drive the conveyor belt 130, an elongated roll 139 is rotatably mounted between the side rails 176 beneath the belt 130, and circumferential surface portions of the roll 139 are provided with a plurality of short, upstanding, radially outwardly extending pins 139a, thereby to provide a so-called pinroll. The pinroll 139 is adapted to engage under surface portions of the conveyor belt 130 and thereby, when rotated, to translate the belt 130. To rotatably drive the pinroll 139, a conventional housed geared motor 138 is mounted on one support plate 178, and the drive shaft (not detailed) of the motor 138 is keyed to one end of the pinroll 139. Actuation of the motor 138 thus translates the belt 130.

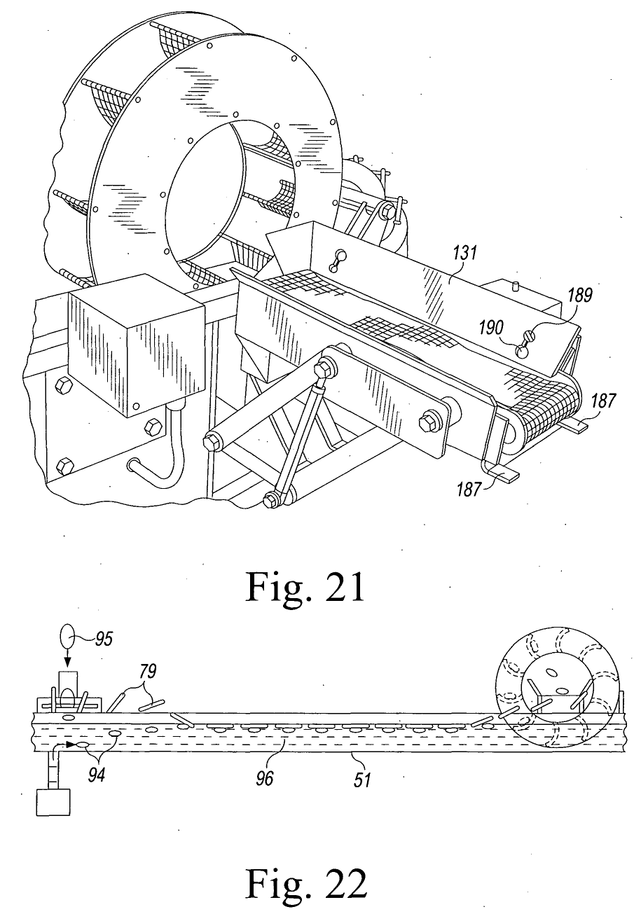

Each support plate 178 is joined adjacent to its respective opposite ends to a different one of a pair of spaced, parallel, cross-sectionally rectangular, steel support bars 182 that downwardly extend therefrom. To opposing corners of a rectangular base plate 183 the bottom end of each bar 182 is connected by swivel bolts 184. The base plate 183 supports the conveyor belt 130 and the related components on the top deck 39. The bolt connections between each opposite end of each bar 182 are adjusted so that the pair of bars 182 associated with each support plate 178 and the base plate 183 are in a pivotable parallelogram configuration relative to each other so that each pair of bars 182 is movable (pivotable) from an upright orientation to a diagonal orientation. Diagonally extending from a lower corner of each side of the base plate 183 to an upper end of one bar 182 where it joins each support plate 178 is a conventional fluid cylinder and associated piston assembly 186. The fluid (conveniently nitrogen or other inert gas) pressure in each cylinder and piston assembly 186 is adjusted so that the conveyor belt 130 and associated components can be manually moved by an apparatus 30 operator from the operative position shown in FIG. 20 outwardly away from the carousel 99 to a cleaning and maintenance position such as illustrated in FIG. 21 and then back again to the operative position.

For further disassembly for cleaning and/or maintenance, the conveyor belt 130 and the side rails 176 are preferably associated by a latching arrangement (not detailed but conventional) with the support plates 178 so that the combination can be disengaged therefrom by manual operation of latches 187 (shown in FIG. 21, not structured but conventional). Preferably the side baffles 131 are disengaged by merely sliding same upwards until their the respective heads of their stationary retaining screws 189 are moved in guidance slots 190 to a location where these screw heads reach an enlargement in the guidance slots 190, as shown, for example, in FIGS. 20 and 21, thereby permitting disengagement of the side baffles 131.

### Operation

As exemplified diagrammatically in FIG. 22, when, for example, slices 94 as cut from a potato 95 that was dropped into the charging chute of a slicer subassembly 32 are discharged into the heated bath oil 96 in the trough or pan 51, the slices 94 initially promptly sink in the bath oil 96 owing to their starting density which reflects the characteristic initial water content of slices 94. Within a few seconds, however, the water in the slices 94 is characteristically heated, boiled and converted to steam which leaves the slices 94, and incidentally also the oil, whereupon the frying slices 94 become lighter in weight and density and rise towards the surface of the oil bath 96. The paddle blade members 79, as horizontally positioned over the bath 96 in pan 51, serve the function of keeping the individual frying slices 94 continuously immersed in the oil bath 96 for a desired time which is necessary to insure that the individual slices 94 are uniformly cooked into potato chips, as desired. Adjustment of movements of the blades 79 as they rotate can advantageously affect the frying of the slices 94.

The interrelationship between such variables as the rate of slice/chip translation circumferentially in and along the oil pan 51, the slice/chip transport or residence time in the oil bath 96, and the temperature and velocity of the oil bath 96 in the pan 51 is such that the individual slice/chip bodies moving in the oil bath 96 are completely converted into desired cooked chips 97 by the time the individual bodies reach the carousel/conveyor subassembly 35. Also, the interrelationship between the apparatus 30 components is such that the individual frying slices 94 in pan 51 tend to progress along and through the oil pan 51 sequentially and so arrive at the carousel subassembly 35 sequentially. As the downward immersing force exerted on the frying slices 94 by the individual paddle wheels 79 bodies is removed when the cam followers 83 engage the cam 91, the cooked chips 97 rise in the oil bath 96 and are carried by the flowing oil of the bath 96 onto individual seats 100 of the rotating carousel 99. Thus, the slicing rate at the slicer subassembly 32, along with the formation of individual slices 94 and the dispensing thereof into the oil bath 96, is preferably synchronized with the spacing between individual frying slices 94 in the bath 96, the velocity and temperature of the bath 96 in the pan 51, and the rotational velocity of the carousel 99. When individual chips 97 in the oil bath 96 reach the rotating carousel 99 in the carousel assembly 35, each chip 97 as cooked is preferably received on a different successive one of the seats 100 of the revolving carousel 99 in the carousel assembly 35.

### Control System

Those skilled in the art will appreciate that frying of foodstuffs using the pan 51, the pump 60 and preferably also oil temperature regulation as herein provided can be carried out by an operator using manual controls.

However, it is preferred to operate the apparatus 30 with electronic controls utilizing generally known technology.

An illustrative and abbreviated control diagram for apparatus 30 operating to cut, fry and separate potato chips employing a conventional PLC (that is, a programmable logic controller) and a known PID (proportional-integral-derivative) algorithm is shown in FIG. 23. The trough position regulation subassembly 34 is preliminarily adjusted to a particular operating pattern. The PLC continuously and successively monitors status signal inputs from components of the apparatus and also regulating inputs that affect apparatus operation. For example, from the apparatus, the PLC also receives inputs regarding temperature of the oil in the trough 51. Regarding regulating inputs, the control loop utilizes certain user (operator) inputs and certain inputs from the slicer subassembly, namely, the input from a photoeye that senses potatoes fed to the slicer and the input from a proximity switch indicating slicer blade rotation. User inputs involve selection of such controllable variables as slicer operating speed and a particular previously programmed apparatus operating sequence for potato chip production. The regulating inputs affect the operation of components of the apparatus. The PLC is programmed to operate the apparatus responsive to permitted regulating inputs.

FIG. 24 diagrammatically illustrates the manner in which temperature of the oil is controlled. Two separate loops are employed. In one loop, which is apart from the PID, the temperature is controlled within a predetermined operating range. Basically, the heater 145 operates if the oil temperature is below this range and does not operate if the oil temperature is above this range. In the second loop, which is responsive to the PID algorithm, oil temperatures that are within the predetermined operating range are, essentially, fine tuned to achieve optimized apparatus operation.

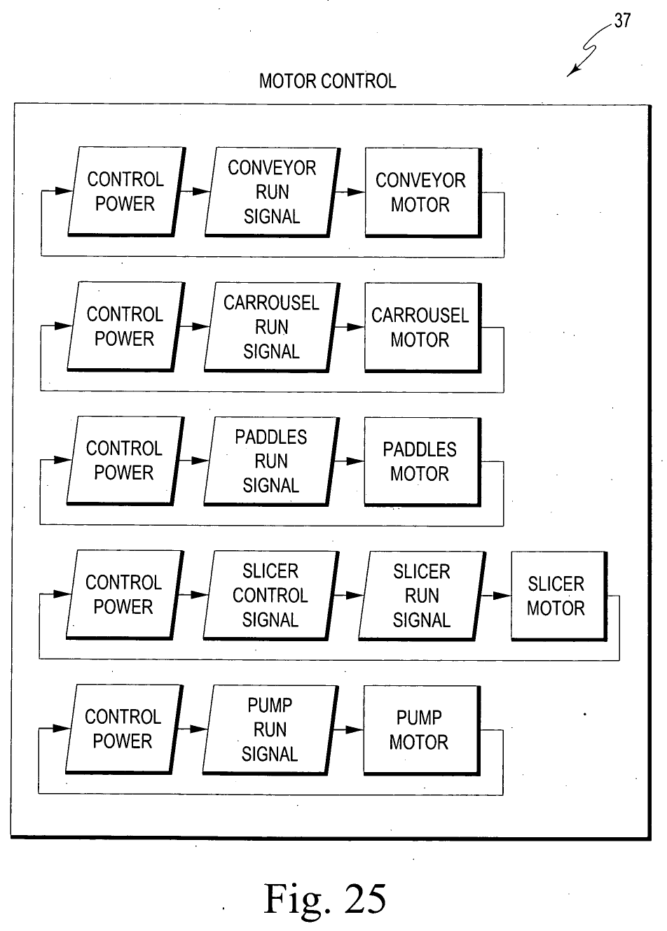

FIG. 25 illustrates how each of the five motors employed in the apparatus 30, that is, the oil pump motor 60, the circular paddle assembly rotating motor 86, the carousel rotating motor 102, the slicer rotating motor 123, and the conveyor translating motor 138, is separately and independently controlled. For each motor, power is separately controlled and a separate and independent motor actuation (“run”) signal is required. In addition, for the slicer, a slicer run signal is necessary.

The FIGS. 23-25 are believed to be self-explanatory so that no detailed description is believed to be necessary.

As is apparent from the foregoing specification and the appended drawings, the invention is susceptible to being embodied in various alternative and modified embodiments which may differ from the particular teachings here disclosed. It should be understood that the present invention includes all such alternative and modified embodiments as reasonably and properly come with the scope of this contribution to the art.

What is claimed is:

1. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unfried chips are dispensed from the slicer into the cooking bath, and the cooking bath is defined by a trough thereof for supporting the cooking medium, the trough providing a cooking path;
at least one submersion screen movable to receive the dispensed chips thereunder after an initial stage of cooking, each submersion screen moving along with the chips during at least a portion of the cooking and serving to maintain the dispensed chips submerged during said portion of the cooking;
a motor system for mechanically communicating with and driving the submersion screen; and
an output from the machine for receiving the cooked chips, wherein cooking path is non-linear and at least two portions thereof are disposed at a distance defining a central portion, and the motor system is mechanically connected with each submersion screen between the two cooking path portions in the central portion.

2. The apparatus of claim 1 wherein each submersion screen is movable so that a portion in contact with the chip received thereunder is movable from a position out of the cooking bath to a position within the cooking bath.

3. The apparatus of claim 1 further including heating elements, the heating elements extending laterally outward from the central portion.

4. The apparatus of claim 3 wherein a portion of the heating elements extend equidistant from the central portion.

5. The apparatus of claim 1 further including:
a slicer having a rotating wheel with a blade secured thereto,
a propulsion device for directing cooking medium of the cooking bath forward, the cooking medium carrying the dispensed unfried chips forward in an initial stage of cooking, the propulsion device being a paddle; and
an output conveyor for removing cooked chips.

6. The apparatus of claim 1 further including:
slicer having a rotating wheel with a blade secured thereto,
a propulsion device for directing cooking medium of the cooking bath forward, the cooking medium carrying the dispensed unfried chips forward in an initial stage of cooking, the propulsion device being a paddle; and
a lifting device for removing cooked chips from the cooking bath, the lifting device including a mesh and positioning the chips above the cooking bath for at least a brief period of time to permit draining of cooking medium.

7. The apparatus of claim 1 further including a programmable logic controller for controlling electrical operation of the apparatus.

8. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unfried chips are dispensed from the slicer into the cooking bath, and the cooking bath is defined by a trough thereof for supporting the cooking medium, the trough providing a cooking path;
at least a first submersion screen movable to receive the dispensed chips thereunder after the initial stage of cooking, each submersion screen moving along with the chips during at least a portion of the cooking and serving to maintain the dispensed chips submerged during said portion of the cooking;
a motor system for mechanically communicating with and driving each submersion screen; and
an output from the machine for receiving the cooked chips, wherein the input is proximate the output so that the cooking bath trough includes at least two cooking path portions with opposite directions of movement during cooking, the two cooking path portions separated by a distance, and the motor system being mechanically connected with the submersion screen between the two cooking path portions.

9. The apparatus of claim 8 wherein each submersion screen is movable so that a portion in contact with the chip received thereunder is movable from a position out of the cooking bath to a position within the cooking bath.

10. The apparatus of claim 8 further including heating elements, the heating elements extending laterally outward from the central portion.

11. The apparatus of claim 10 wherein a portion of the heating elements extend equidistant from the central portion.

12. The apparatus of claim 8 wherein the slicer includes a rotating wheel with a blade secured thereto.

13. The apparatus of claim 8 further including a propulsion device for directing cooking medium of the cooking bath forward, the cooking medium carrying the dispensed unfried chips forward in an initial stage of cooking

14. The apparatus of claim 8 wherein the propulsion device is a paddle.

15. The apparatus of claim further including a lifting device for removing cooked chips from the cooking bath, the lifting device including a mesh and positioning the chips above the cooking bath for at least a brief period of time to permit draining of cooking medium.

16. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unified chips are dispensed from the slicer into the cooking bath, and the cooking bath is defined by a trough thereof for supporting the cooking medium, the trough providing a cooking path;
at least a first submersion screen movable along the cooking path to receive the dispensed chips thereunder after an initial stage of cooking, each submersion screen moving along with the chips during at least a portion of the cooking and serving to maintain the dispensed chips submerged during said portion of the cooking;
a motor system for mechanically communicating with and driving each submersion screen; and
an output from the machine for receiving the cooked chips, wherein cooking path is non-linear and at least two portions thereof are disposed at a distance defining a central portion, and the motor system is mechanically connected with each submersion screen between the two cooking path portions in the central portion.

17. A system including an apparatus for preparing fried food chips and a control for operating said apparatus, the system comprising:
the apparatus including:
an input for dispensing food chips,
a cooking bath for supporting and retaining cooking medium, the cooking bath receiving the dispensed food chips,
a heating system for heating the cooking medium, and
an advancing system for advancing the food chips along a cooking path of the cooking bath; and
the control including a main control for controlling the input, the heating system, and the advancing system.

18. The system of claim 17 wherein the main control is programmable logic controller-based.

19. The system of claim 18 wherein the main control communicates with a remote operator via a communication line.
